(19) United States
(12) Patent Application Publication
(10) Pub. No.: US 2008/0168700 A1
(43) Pub. Date: Jul. 17, 2008

(54) Fishing tackle

(76) Inventor: Sun Sam KIM, Gyeonggi-do (KR)

Correspondence Address: BACON & THOMAS, PLLC, 625 SLATERS LANE, FOURTH FLOOR, ALEXANDRIA, VA, 22314, US

(21) Appl. No.: 11/979,393

(22) Filed: Nov. 2, 2007

(30) Foreign Application Priority Data
Jan. 12, 2007 (KR) 20-2007-0000632

(51) Int. Cl. A01K 85/02

(52) U.S. Cl. 43/42.24; 43/42.44

(57) ABSTRACT

A fishing tackle includes a worm for luring a target fish, a hook inserted into the worm and hooking the target fish, and a sinker for fixing the worm and the hook. The sinker includes a head portion that has a fixing hole formed at a rear end portion in which a fishing line is knotted and a through-hole formed at a central portion through which a fixed portion of the hook is inserted, and an insertion portion integrally protruded from a front end of the head portion and inserted into the worm to combine the worm and the sinker. Because the sinker is firmly fixed at the worm, no waterweed is wound between the worm and the sinker and the worm is not readily damaged, so that the worm can be re-used.

### FIELD OF THE INVENTION

The present invention relates to a fishing tackle; and, more particularly, to a fishing tackle capable of re-using a worm (e.g., an artificial plastic worm) and easily hooking a target fish.

### BACKGROUND OF THE INVENTION

In general, a fishing tackle is one of fishing accessories, which has a function of helping a fisher to sense biting of a fish, recognize the fish's biting state and determine a point of time for landing the fish, as well as balancing a fishing line that freely moves along a water current. The fishing tackle commonly includes a heavy sinker, a worm and a hook. The worm for luring a target fish is made of various materials and in various forms depending on types of target fishes and is positioned on the surface of the water or underwater.

FIG. 1 is a view illustrating a fishing tackle in accordance with the related art and FIGS. 2A to 2C are views illustrating a sequence of combining the fishing tackle shown in FIG. 1.

In general, the tackle 1 includes a worm 10 having various shapes such as a fish or a worm (bug), a hook 20 having one end to which the fishing line 2 is connected, the hook 20 penetrating the warm 10 and protruding therefrom, and a sinker 30 through which the fishing line 2 is penetratingly inserted, the sinker 30 being positioned at an upper end of the worm 10 and helping the tackle 1 to fly to a desired position. Here, the hook 20 includes a hook portion 21 having a needle tip and a fixed portion 22 extending from the end of the hook portion 21 opposite to the needle tip, the fixed portion 22 being bent substantially “L” shape to be fixed at the worm 10.

The assembling process of the tackle 1 will now be described with reference to FIGS. 2A to 2C. First, the hook portion 21 of the hook 20 is inserted from an upper end of the worm 20 to penetrate the body thereof such that a part of the needle pin is protruded from the worm 10 and the fixed portion 22 is fixed at the upper end of the worm 10. In this state, the sinker 30 is connected with the fishing line and positioned at the upper end of the worm 10.

However, in the conventional fishing tackle, because the sinker 30 is not fixed at the worm 10, waterweed or water grass are wound between the sinker 30 and the worm 10 in an area where there are a lot of waterweed or water grass. Further, when a target fish bites the worm 10 or the hook 20, the worm 10 may readily be broken by the fixed portion 22 of the hook 20 due to the force of the target fish, which makes it impossible to re-use the worm 10.

### SUMMARY OF THE INVENTION

It is, therefore, an object of the present invention to provide a fishing tackle capable of preventing waterweed from being wound between a worm and a sinker to suppress the worm from being readily damaged, thereby allowing the worm to be re-used.

Another object of the present invention is to provide a fishing tackle capable of increasing the possibility of fishing by making a hook rotatable within a certain range so that, when a target fish bites a worm and the hook, the hook is rotated to be protruded from the worm, thus allowing the hook to stick into the target fish deeply.

In accordance with an aspect of the present invention, there is provided a fishing tackle including: a worm for luring a target fish; a hook, inserted into the worm, for hooking the target fish; and a sinker for fixing the worm and the hook, wherein the sinker includes: a head portion that has a fixing hole formed at one end portion in which a fishing line is knotted and a through-hole formed at a central portion through which a fixed portion of the hook is inserted; and an insertion portion protruded from the other end portion of the head portion, the insertion portion being inserted into the worm to combine the worm and the sinker.

Preferably, support recesses communicating with the through-hole are formed on opposite surfaces of the head portion of the sinker, and the fixed portion of the hook is bent substantially “L” shape and its end portion is supported within one of the support recesses.

Further, the insertion portion may have a sharp end point and include a plurality of engagement protrusions along its axial direction to increase an engagement force for binding the worm and the insertion portion. In this case, the engagement protrusions of the insertion portion may have a tapered shape that converges toward the sharp end point.

### BRIEF DESCRIPTION OF THE DRAWINGS

The above and other objects and features of the present invention will become apparent from the following description of embodiments given in conjunction with the accompanying drawings, in which:

FIG. 1 is a view illustrating a conventional fishing tackle;

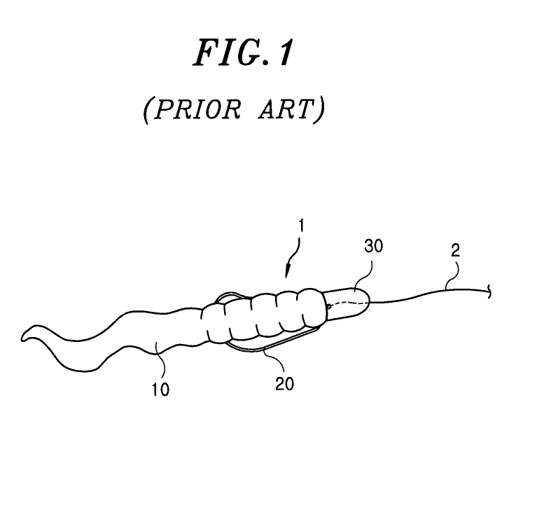

FIGS. 2a to 2c are views illustrating a sequence of assembling a hook and a worm of the fishing tackle shown in FIG. 1;

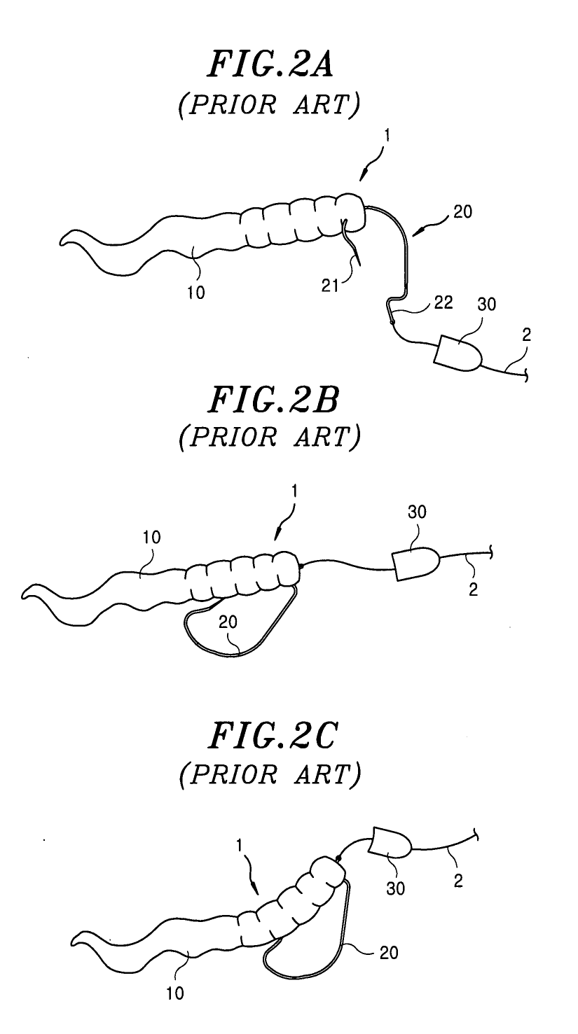

FIG. 3 is an exploded perspective view of a fishing tackle in accordance with an embodiment of the present invention;

FIGS. 4 and 5 are top and bottom perspective views of a sinker of the fishing tackle in accordance with the embodiment of the present invention;

FIG. 6 is a sectional view of the sinker of the fishing tackle in accordance with the embodiment of the present invention; and

FIGS. 7A to 7D show a sequence of assembling process of the fishing tackle in accordance with the embodiment of the present invention.

### DETAILED DESCRIPTION OF THE PREFERRED EMBODIMENT

Hereinafter, a fishing tackle in accordance with an embodiment of the present invention will be described in detail with reference to the accompanying drawings.

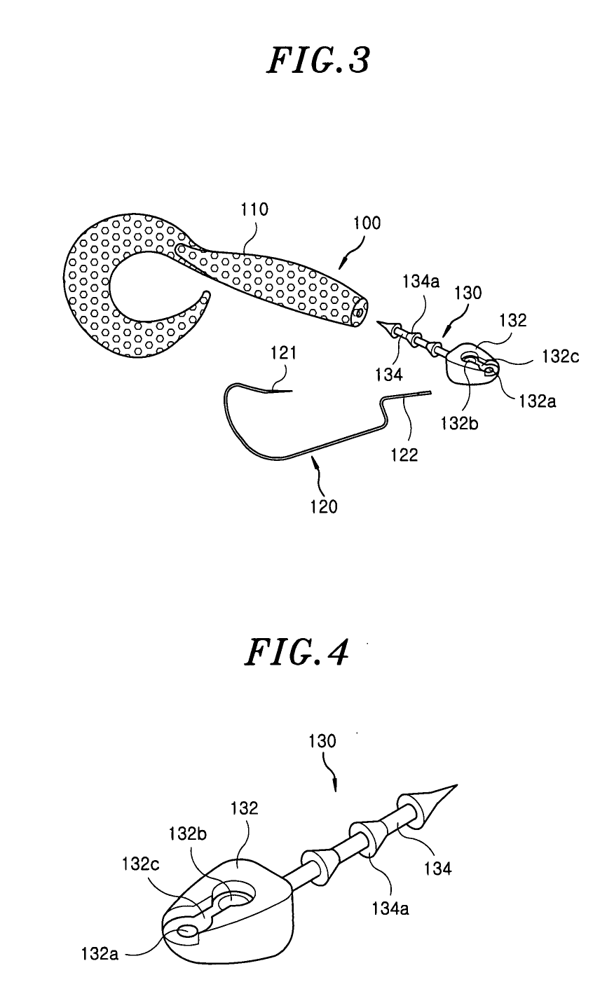

FIG. 3 is an exploded perspective view of a fishing tackle in accordance with the embodiment of the present invention. As shown in FIG. 3, a fishing tackle 100 includes a worm 110 for luring a target fish, the worm 110 being formed in various shapes such as a fish or a worm (bug), a hook 120 extended through the worm 110 to hook the target fish, and a sinker 130 for assisting the worm 110 and the hook 120 to be hurled at a desired position.

Preferably, the worm 110 has a hole into which an insertion portion 134 of the sinker 130 is inserted and is made of a soft silicon material so as to be moved along waves in water. Further, the hook includes a hook portion 121 with a needle tip and a fixed portion 122 extending from an end of the hook portion 121 opposite to the needle tip, the fixed portion 122 being bent in substantially “L” shape.

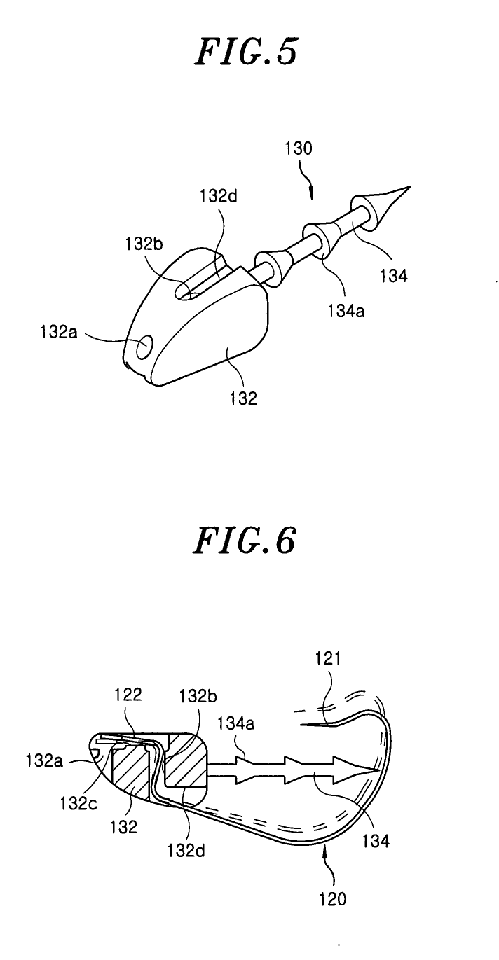

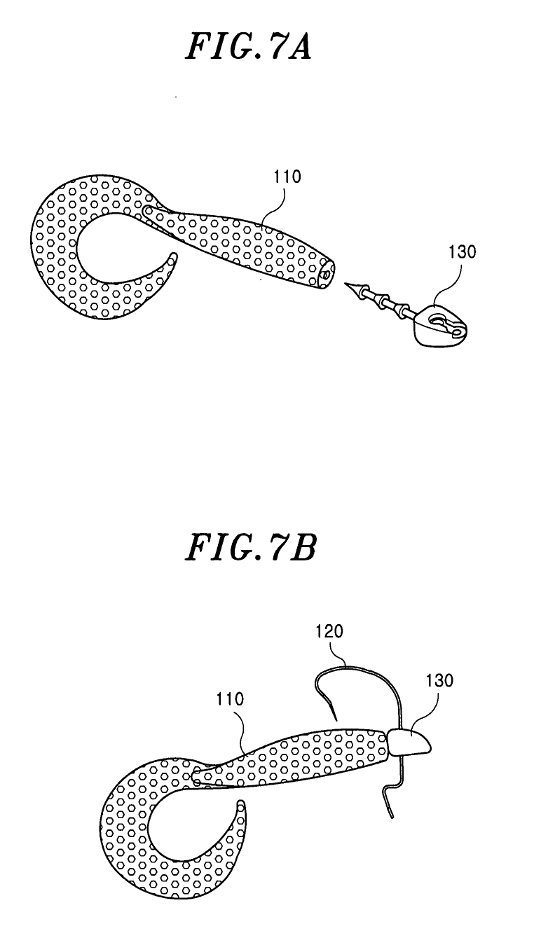

FIGS. 4 and 5 are top and bottom perspective views of the sinker of the fishing tackle as viewed from above and below, respectively. FIG. 6 is a sectional view of the sinker of the fishing tackle. As shown in FIGS. 4 and 5, the sinker 130 includes a head portion 132 made of lead or brass having a weight, and the insertion portion 134 is integrally formed with the head portion 132 and extending from a front end of the head portion 132 so as to be inserted and fixed at the worm 110.

The head portion 132 has a substantially right angle with a smoothly curved inclined plane and round corners when viewed from a side. A fixing hole 132a is formed at a rear end portion of the head portion 132, opposing the insertion portion 134, and a fishing line 2 is knotted in the fixing hole 132a. A vertical through-hole 132b is formed at a central portion of the head portion 132, into which the fixed portion 122 of the hook 120 is inserted. Support recesses 132c and 132d are formed on a top surface and a bottom surface (inclined plane) of the head portion 132, the support recesses 132c and 132d being respectively extended from the rear end and the front end to the central portion so as to communicate with the through-hole 132b. That is, the through-hole 132b and the support recesses 132c and 132d communicate with each other.

The fixed portion 122 of the hook 120 is inserted through the through-hole 132b from below to be protruded from the top surface of the head portion 132, so that, as shown in FIG. 6, the end of the “L”-shaped fixed portion 122 is supported by the support recess 132c, allowing the hook 120 to be held in the head portion 132 of the sinker 130.

Preferably, the support recesses 132c and 132d have a width same as or slightly greater than that of the fixed portion 122 of the hook 120.

The insertion portion 134 extends from a central portion of the front end of the head portion 120 and has a sharp end point. The insertion portion 134 includes a plurality of tapered engagement protrusions 134a that converge toward the sharp end point along its axial direction to increase engagement (binding force) with the worm 100. Although not shown, the engagement protrusion 134a may be formed in a spiral pattern.

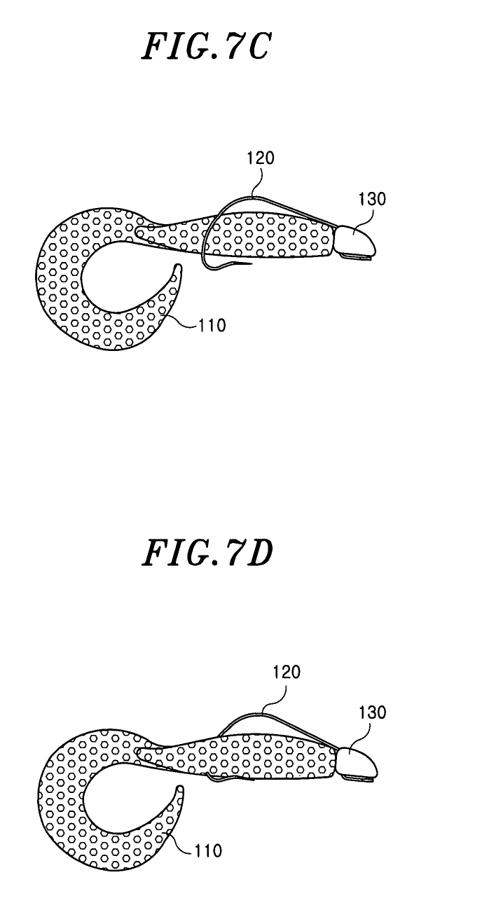

The assembling and operation of the fishing tackle will now be described with reference to FIGS. 7A to 7D. FIGS. 7A to 7D show a sequence of assembling process of the fishing tackle.

First, as shown in FIG. 7A, the insertion portion 134 of the sinker 130 is forcibly inserted into the rear end portion of the worm 110. In this case, the rear end portion of the worm 110 may include the insertion hole to facilitate inserting of the insertion portion 134. The engagement between the worm 110 and the insertion portion 134 is increased by virtue of the plurality of tapered engagement protrusions 134a.

Next, with reference to FIGS. 7B to 7D, the fixed portion 122 of the hook 120 is inserted into the through-hole 132b of the head portion 132 of the sinker 130 while the fishing line 2 is knotted in the fixing hole 132a, and then the hook portion 121 is stuck into the worm 110 such that it is buried therein or partially protruded therefrom. In this case, the fixed portion 122 of the hook 120 is positioned within the support recess 132c.

In such a state, the worm 110 and the sinker 130 are firmly combined together, so that it is possible to prevent waterweed from being wound between the worm 110 and the sinker 130 while a user is fishing with the fishing tackle.

When a target fish bites the hook 120 and strongly pulls the hook 120 in the opposite direction of the fishing line 2, the hook 120 rotates in an upward direction as shown in FIG. 6, and accordingly, the hook portion 121 is further protruded from the worm 110 to make the mouth of the target fish firmly hooked by the hook portion 121. In addition, when the hooked target fish is released, it can be easily released from the hook portion 121 without damaging the worm 110 since the hook 120 is rotated to make the gap between the needle tip of the hook 120 and the worm 110 broad.

The fixed portion 122 is supported within the support recess 132c to limit the rotation of the hook 120 to thus prevent the hook 120 from being released from the sinker 130.

In accordance with the present invention, because the sinker 140 has the head portion 132 to which the hook 120 is fixed and the insertion portion 134 which is inserted into the worm 110 and fixed thereto, no waterweed is wound between the worm 110 and the sinker 140 and the worm 110 can be re-used without being damaged.

As described above, in the fishing tackle in accordance with the present invention, the sinker is fixed at the worm, so that waterweed cannot be wound between the worm and the sinker and the worm is not readily damaged, whereby the worm can be re-used. In addition, since the hook is rotatably fixed at the sinker, when the target fish bites the worm and the hook, the hook rotates to be protruded from the worm, broadening the gap between the needle tip of the hook and the worm. Thus, the target fish can be more deeply stuck, which remarkably increases the possibility of fishing.

While the invention has been shown and described with respect to the embodiment, it will be understood by those skilled in the art that various changes and modifications may be made without departing from the scope of the invention as defined in the following claims.

What is claimed is:

1. A fishing tackle comprising:
a worm for luring a target fish;
a hook, inserted into the worm, for hooking the target fish; and
a sinker for fixing the worm and the hook,
wherein the sinker comprises:
a head portion that has a fixing hole formed at one end portion in which a fishing line is knotted and a through-hole formed at a central portion through which a fixed portion of the hook is inserted; and
an insertion portion protruded from the other end portion of the head portion, the insertion portion being inserted into the worm to combine the worm and the sinker.

2. The fishing tackle of claim 1, wherein a support recess communicating with the through-hole is formed on a surface of the head portion of the sinker, and the fixed portion of the hook is bent substantially “L” shape and its end portion is supported within the support recess.

3. The fishing tackle of claim 1, wherein support recesses communicating with the through-hole are formed on opposite surfaces of the head portion of the sinker, and the fixed portion of the hook is bent substantially “L” shape and its end portion is supported within one of the support recesses.

4. The fishing tackle of claim 1, wherein the insertion portion has a sharp end point and includes a plurality of engagement protrusions along its axial direction to increase an engagement force for binding the worm and the insertion portion.

5. The fishing tackle of claim 4, wherein the engagement protrusions of the insertion portion have a tapered shape that converges toward the sharp end point.
